(19) United States
(12) Patent Application Publication
(10) Pub. No.: US 2021/0323807 A1
(43) Pub. Date: Oct. 21, 2021

(54) Fuel pump handle guard

(71) Applicant: Michael Brown, Holiday, FL (US)

(72) Inventor: Michael Brown, Holiday, FL (US)

(21) Appl. No.: 16/851,150

(22) Filed: Apr. 17, 2020

(51) Int. Cl. B67D 7/42

(52) U.S. Cl. CPC B67D 7/421

(57) ABSTRACT

The device disclosed within as a reusable fuel pump handle guard. A user holds the handle guard in his or her hand, with his palm against the grip, and fingers extending down the two parallel elements. He then applies the hand guard to the hand rest of the fuel pump. A shoulder located at the front edge of the grip prevents the user's hand from sliding too far forward and off the handle guard. The flexible material of the handle guard allows the user to bend the receiving element toward the latching element, around the grip of the gas pump, and underneath the handle of the gas pump actuating the pump ultimately passing the hook of the latching element into the hole of the receiving element.

### FIELD

This invention relates to the field of handle barriers and more particularly to a device for protecting user's hand from dirty fuel pump handles.

### BACKGROUND

The most common mechanism for passing viruses and bacteria is contact. Whether shaking hands, contacting shared surfaces, or handing over items, each presents the problem of passing infectious agents from one person to another. Transmitting bacteria and viruses is always an issue, but particularly during times such as flu season.

As this application is being drafted, the novel Coronavirus, or COVID-19 is rapidly spreading around the world. In response to this pandemic, certain social interactions have changed. For example, most people are currently not shaking hands, are working from home, and are limiting grocery store trips.

But certain activities of daily life cannot be suspended even in the times of a pandemic. For example, using the fuel pump at a filling station. Everyone with a vehicle must go to a filling station, particularly first responders and other individuals who must drive even more during periods of crisis.

When using a filling station, one may elect to use disposable gloves. But the COVID-19 pandemic has led to shortages of supplies. Thus to use gloves for such a mundane task seems wasteful.

What is needed is a device that allows a user to operate a fuel pump without the use of disposable consumable supplies such as gloves.

### SUMMARY

The device disclosed within as a reusable fuel pump handle guard. A user holds the handle guard in his or her hand, with his palm against the grip, and fingers extending down along the two parallel elements—a latching element and a receiving element.

The user then applies the hand guard to the hand rest of the fuel pump.

A shoulder located at the front edge of the grip prevents the user's hand from sliding too far forward and off the handle guard.

The reusable fuel pump handle guard is preferably formed from a flexible material that allows the user to bend the receiving element toward the latching element, around the grip of the gas pump, and underneath the handle of the gas pump. The compression of the handle guard against the lever actuates the pump, and ultimately allows the hook of the latching element to engage the hole of the receiving element.

The receiving element are latching element are also referred to as downwardly-extending legs, able to lock into each other and form an enclosed space.

The material is also preferably resilient, returning to its original shape after use.

In an alternative embodiment, the reusable fuel pump handle guard is formed from a rigid material, with the receiving element/latching element connected to the grip by hinges.

In an additional alternative embodiment, the reusable fuel pump handle guard is partially flexible and partially rigid. For example, the grip is rigid or inflexible, but the receiving element and latching element are flexible.

Regardless of the combination of rigid and flexible materials, the result is that the handle guard encircles the fuel pump hand rest and lever, causing the gas pump to dispense gasoline until the automatic disconnect is triggered.

When the user wishes to stop fuel from dispensing, he can again squeeze the handle guard to disconnect the hook from the hole. The handle guard is then readily removable.

The handle guard is reusable and easily sanitized using cleaning agents or hand sanitizer.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a first isometric view of the handle guard.

FIG. 2 illustrates a second isometric view of the handle guard.

FIG. 3 illustrates a front view of the handle guard in a latched position.

FIG. 4 illustrates a right side view of the handle guard.

FIG. 5 illustrates a view of a fuel pump handle of the handle guard.

FIG. 6 illustrates a second front view of the handle guard in a latched position around a fuel pump handle.

FIG. 7 illustrates a left side view of the handle guard.

FIG. 8 illustrates a back view of the handle guard.

FIG. 9 illustrates a front view of the handle guard.

FIG. 10 illustrates a top view of the handle guard.

FIG. 11 illustrates a bottom view of the handle guard.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

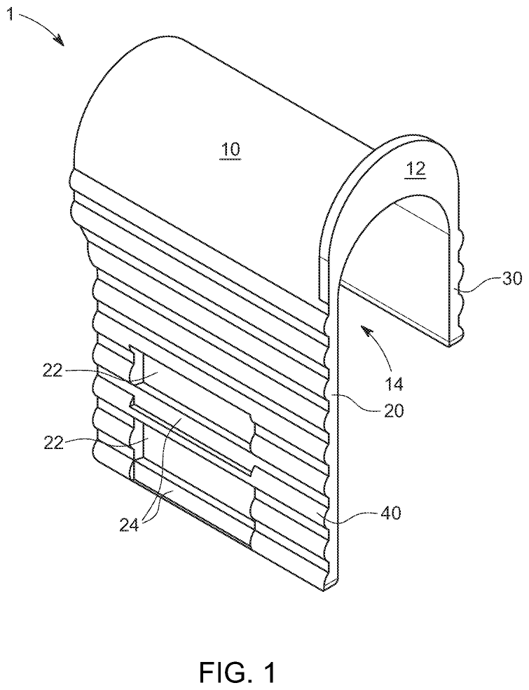

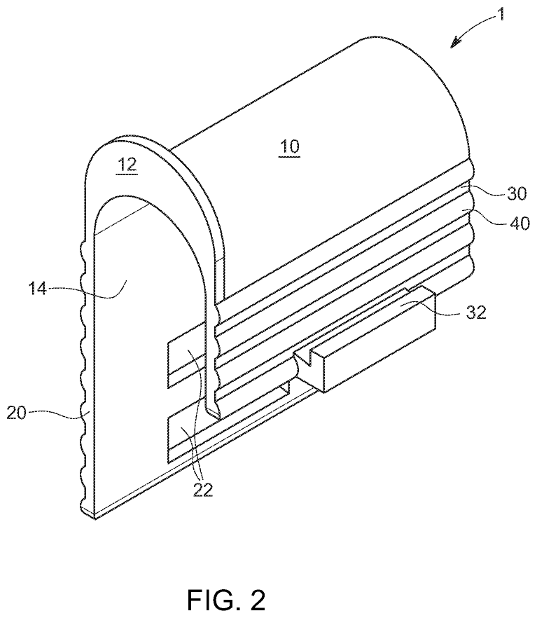

Referring to FIGS. 1 and 2, a first isometric view and a second isometric view of the handle guard are shown.

The handle guard 1 is formed primarily from a grip 10, with downward-extending flexible receiving element 20 and latching element 30.

The grip 10 ends in a shoulder 12, against which a user can rest the space between his thumb and index finger—the front edge of this palm.

The space between the receiving element 20 and latching element 30 creates a gap 14, info which the item to be held, such as a fuel pump handle, is slid.

The receiving element 20 includes one or more holes 22, and optional locking face 24.

The latching element 30 includes a hook 32 that during use slides into the hole 22 and rests against the locking face 24.

Optionally included are gripping ribs 40 that help the user's fingers to hold the handle guard 1 and change its shape.

While the receiving element 20 and latching element 30 are preferably formed from a flexible material, in alternative embodiments the receiving element 20 and latching element 30 and formed from rigid materials, and connected to the grip 10 by hinges. The hinges can be living hinges, or typical butt hinges.

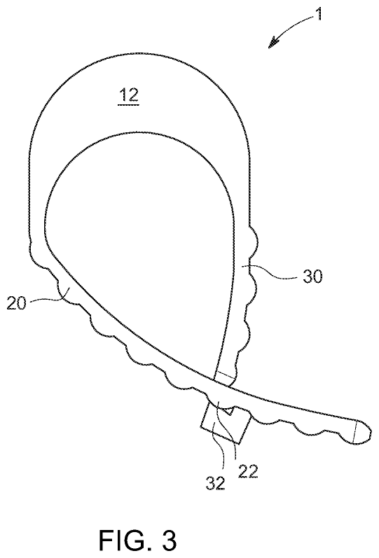

Referring to FIG. 3, a front view of the handle guard in a latched position is shown.

The receiving element 20 has flexed toward the latching element 30, allowing the hook 32 to pass through the hole 22.

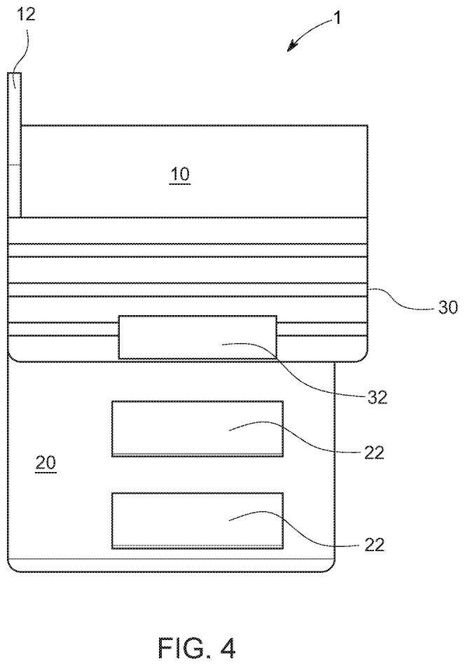

Referring to FIG. 4, a right side view of the handle guard is shown.

The handle guard 1 includes the grip 10 with shoulder 12, extending downward into the receiving element 20 and latching element 30.

The receiving element 20 includes one or more holes 22.

The gripping ribs 40 help the user's fingers to hold the handle guard 1 and alter its shape.

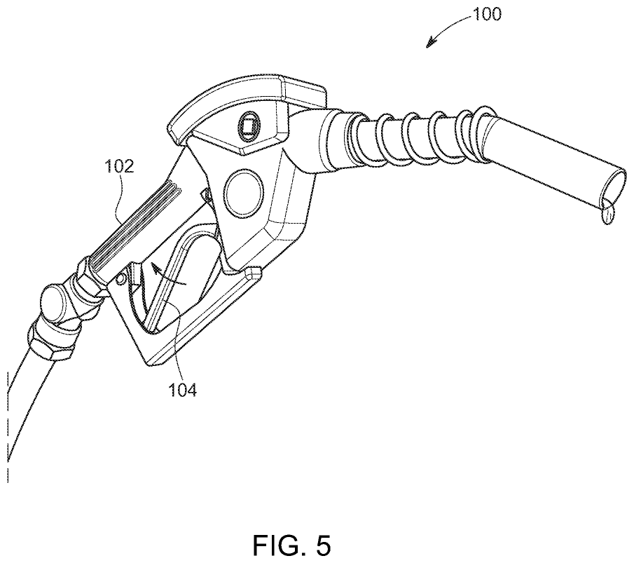

Referring to FIG. 5, a view of a fuel pump handle of the handle guard is shown.

The gas pump handle 100 includes a hand rest 102 and lever 104. Actuating the lever 104 toward the hand rest 102 causes fuel to be dispensed.

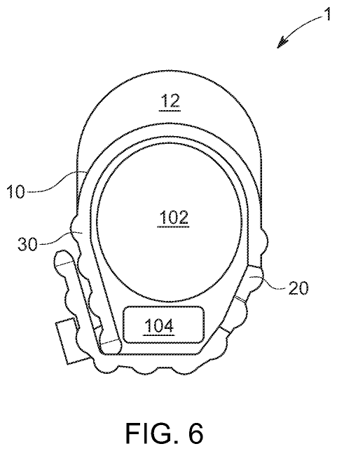

Referring to FIG. 6, a second front view of the handle guard in a latched position around a fuel pump handle is shown.

The grip 10 rests against the hand rest 102 of the gas pump handle 100 (see FIG. 5), the receiving element 20 wrapping around the lever 104.

When latched, the handle guard 1 provides the additional benefit of holding the lever 104 in an actuated position, allowing for unattended filling of the user's gas tank.

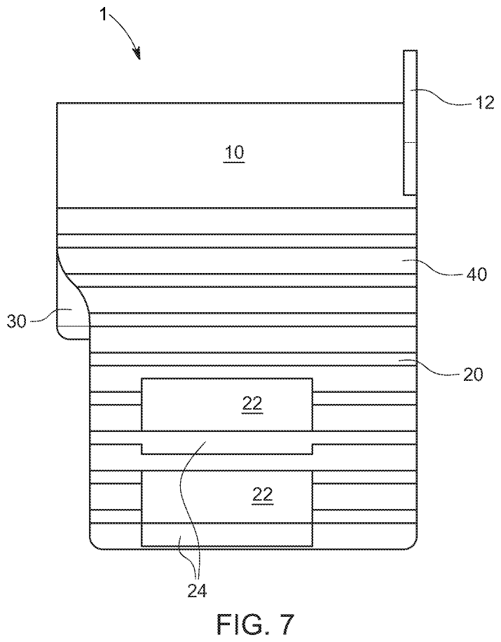

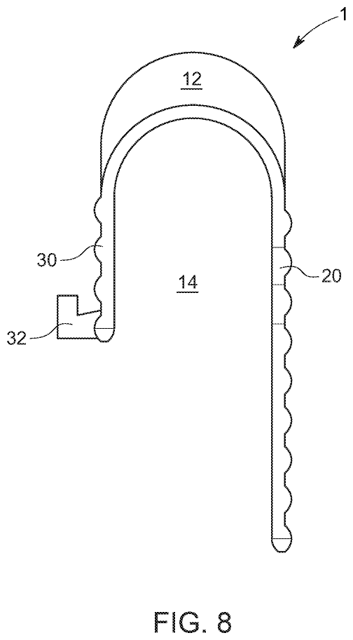

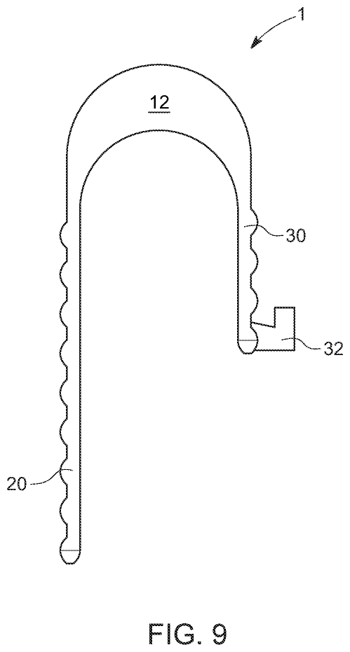

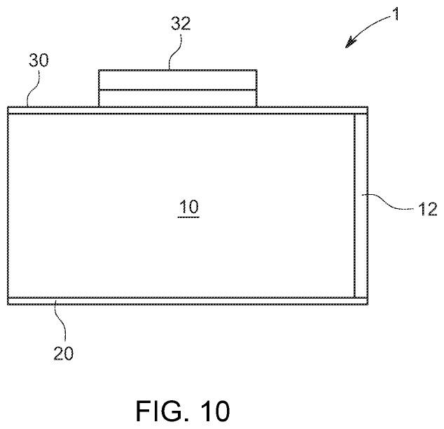

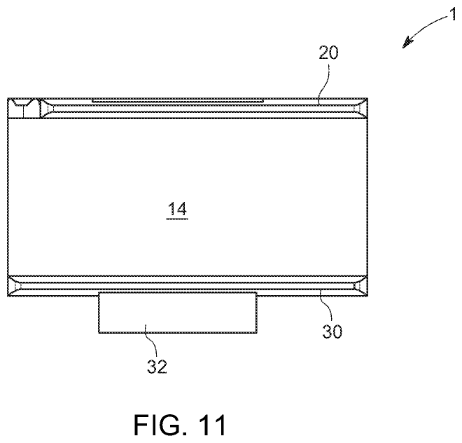

Referring to FIGS. 7-11, multiple views of the handle guard are shown.

The handle guard 1 is shown with receiving element 20 including holes 22, and locking face 24. The latching element 30 includes a hook 32. A gap 14 exists between receiving element 20 and latching element 30.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction, and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A hand guard for use with a fuel pump handle comprising:
a body with a grip, from which extend:
a receiving element including one or more holes; and
a latching element;
the receiving element and latching element able to bend toward each other and reach a connected position;
a hook extending from the latching element;
the hook interfacing with the one or more holes of the receiving element;
whereby the hand guard forms a barrier around the fuel pump handle.

2. The hand guard of claim 1, wherein:
an outer surface of the receiving element includes protruding ribs;
whereby the protruding ribs make it easier to grip the hand guard.

3. The hand guard of claim 1, wherein the hand guard is constructed from a flexible, resilient material that a user may bend with her hand.

4. The hand guard of claim 1, further comprising:
a locking face adjacent to each of the one or more holes of the receiving element;
the latching element resting against the locking face when the receiving element and latching element are in the connected position.

5. The hand guard of claim 1, wherein:
the grip is formed from an inflexible material;
the receiving element and latching element are formed from a flexible material;
whereby during use the receiving element and latching element can bend toward each other, connecting under the body.

6. A removable, washable, hand guard for use partially-enclosing a handle of a fuel pump, the hand guard comprising:
a grip with downwardly-extending legs;
the grip and downwardly-extending legs passing around the handle of the fuel pump, between a user's hand and the handle;
whereby the hand guard is applied to a fuel pump handle to allow operation of the fuel pump without direct contact by the user's hand to the handle.

7. The removable, washable, hand guard of claim 6, wherein:
the downwardly-extending legs can lock into each other, creating an enclosed space.

8. The removable, washable, hand guard of claim 7, wherein:
the downwardly-extending legs include:
a latch; and
one or more holes;
the latch locking into the one or more holes to create the enclosed space.

9. The removable, washable, hand guard of claim 6, wherein:
an outer surface of the downwardly-extending legs includes protruding ribs;
whereby the protruding ribs make it easier to grip the hand guard.

10. The removable, washable, hand guard of claim 6, wherein the hand guard is constructed from a flexible, resilient material that a user may bend with her hand.

11. The removable, washable, hand guard of claim 8, further comprising:
a locking face adjacent to each of the one or more holes of the downwardly-extending legs;
the latching element resting against the locking face when the receiving element and latching element are in a connected position.

12. The removable, washable, hand guard of claim 7, wherein:
the grip is formed from an inflexible material;
the downwardly-extending legs are formed from a flexible material;
whereby during use the downwardly-extending legs can bend toward each other, connecting under the grip.

13. A fuel pump handle guard comprising:
a body with a protruding receiving element and a protruding latching element;
the protruding receiving element and the protruding latching element able to temporarily affix to each other, closing the fuel pump handle guard around an object such as a fuel pump handle;
whereby the fuel pump handle guard allows operation of a fuel pump without contact between a user's hand and the fuel pump.

14. The fuel pump handle guard of claim 13, wherein:
an outer surface of the receiving element includes protruding ribs;
whereby the protruding ribs make it easier to grip the hand guard.

15. The fuel pump handle guard of claim 13, wherein the fuel pump handle guard is constructed from a flexible, resilient material that a user may bend with her hand.

16. The fuel pump handle guard of claim 13, further comprising:
a locking face adjacent to each of the one or more holes of the receiving element;
the latching element resting against the locking face when the receiving element and latching element are in a connected position.

17. The fuel pump handle guard of claim 13, wherein:
the body is formed from an inflexible material;
the protruding receiving element and protruding latching element are formed from a flexible material;
whereby during use the receiving element and latching element can bend toward each other, connecting under the grip.
